(19) United States
(12) Patent Application Publication
(10) Pub. No.: US 2021/0242655 A1
(43) Pub. Date: Aug. 5, 2021

(54) OPTICAL FIBER AMPLIFIER

(71) Applicant: SUMITOMO ELECTRIC INDUSTRIES, LTD., Osaka-shi, Osaka (JP)

(72) Inventor: Takafumi OHTSUKA, Osaka-shi (JP)

(73) Assignee: SUMITOMO ELECTRIC INDUSTRIES, LTD., Osaka-shi, Osaka (JP)

(21) Appl. No.: 17/262,958

(22) PCT Filed: Sep. 26, 2019
(86) PCT No.: PCT/JP2019/038042

§ 371 Date: Jan. 25, 2021

(30) Foreign Application Priority Data
Sep. 28, 2018 (JP) 2018-185277

(51) Int. Cl. H01S 3/067; G02B 6/02

(52) U.S. Cl. CPC H01S 3/06754; H01S 3/0672; G02B 6/02085; G02B 6/021; G02B 6/02042

(57) ABSTRACT

An optical fiber amplifier according to one embodiment includes a multicore fiber doped with erbium, and the multicore fiber is twisted and helically wound to form a fiber coil.

### TECHNICAL FIELD

One aspect of the present disclosure relates to an optical fiber amplifier.

This application claims the priority based on Japanese Patent Application No. 2018-185277 filed on Sep. 28, 2018, which is hereby incorporated by reference in its entirety.

### BACKGROUND ART

Non-Patent Literature 1 discloses an optical amplification technique for a multicore fiber (MCF) system that uses a multicore fiber to increase the density of transmission lines. An MCF for use in amplification is applied to the optical amplification technique for an MCF system. As the MCF for use in amplification, a multicore erbium-doped fiber (EDF) including seven cores doped with erbium is disclosed. In the multicore EDF, the cores are arranged in a hexagonal close-packed structure, and a distance between the cores is set as long as 49.5 μm to suppress crosstalk. Non-Patent Literature 1 further discloses a multicore EDF that suppresses crosstalk by making a propagation direction of an optical signal through a core and a propagation direction of an optical signal through a core adjacent to the core opposite to each other.

Non-Patent Literature 2 discloses a technique for suppressing crosstalk in a coupled MCF. Non-Patent Literature 2 discloses that an average value μₓ of crosstalk is expressed by an equation (1) where a bending radius of the coupled MCF is denoted by R_{b}, a distance between a center of a core n and a center of a core m of the coupled MCF is denoted by Dₙₘ, an inherent effective refractive index of the core n is denoted by n_{eff, c, n}, a length of the optical fiber is denoted by L, a wavelength is denoted by λ, and a coupling coefficient is denoted by κₙₘ.

$$\begin{matrix}[ Formula . 1 ] & \\ {μ}_{x} = {κ}_{nm}^{2} \frac{λ {R}_{b} L}{π {n}_{eff , c , n} {D}_{nm}} & ( 1 )\end{matrix}$$

The equation (1) shows that the average value μₓ of crosstalk is proportional to the length L of the optical fiber and the bending radius R_{b}.

### CITATION LIST

### Non Patent Literature

Non Patent Literature 1: Yamada et al., “Multi-Core Erbium-Doped Fiber for Space-Division Multiplexing”, Fujikura technical journal No. 127
Non Patent Literature 2: Hayashi, et al., “Multi-Core Optical Fibers for Next-Generation Communications”, SEI Technical Review No. 192

### SUMMARY OF INVENTION

An optical fiber amplifier according to one aspect of the present disclosure is an optical fiber amplifier including a multicore fiber doped with erbium. The multicore fiber is twisted and helically wound to form a fiber coil.

An optical fiber amplifier according to another aspect of the present disclosure is an optical fiber amplifier including a multicore fiber doped with erbium. The multicore fiber is helically wound to form a fiber coil. The multicore fiber includes, in a cross section intersecting a longitudinal direction of the multicore fiber, a center core located at a center of the cross section and outer cores located around the center core. A minimum angle φ formed by a binormal vector extending in an axial direction of the fiber coil and a vector extending from the center core toward one of the outer cores located outside the center core in a radial direction of the helix is at least 0.3°.

### BRIEF DESCRIPTION OF DRAWINGS

FIG. 1 is a perspective view schematically showing an optical fiber amplifier according to a first embodiment.

FIG. 2 is a plan view of a fiber coil of the optical fiber amplifier shown in FIG. 1.

FIG. 3 is a cross-sectional view taken along line III-III of FIG. 2.

FIG. 4 is a cross-sectional view taken along line IV-IV of FIG. 2.

FIG. 5 is a graph showing an example of a relation between a distance in a longitudinal direction of the fiber coil and a rotation angle of a core.

FIG. 6 is a perspective view schematically showing an optical fiber amplifier according to a second embodiment.

FIG. 7 is a cross-sectional view of a multicore fiber of the optical fiber amplifier shown in FIG. 6.

FIG. 8 is a graph showing a relation between a bending radius of an optical fiber and a power coupling coefficient in various optical fiber amplifiers.

FIG. 9 is a graph showing a relation between signal input, and gain and noise figure for various optical fiber amplifiers.

### DESCRIPTION OF EMBODIMENTS

### Technical Problem

An optical fiber amplifier includes a multicore erbium-doped optical fiber including a coupled MCF that allows optical coupling between cores. Such an optical fiber amplifier may have poor performance as compared with an optical fiber amplifier including an uncoupled MCF that does not allow optical coupling between cores. Specifically, in an optical fiber amplifier including the coupled MCF (coupled amplifier), amplified spontaneous emissions (ASE) produced in adjacent cores are coupled. Then, in addition to the ASEs produced by signal light or the like, an induced emission produced by the coupled ASE from the adjacent core de-excites the erbium ions in the excited state, which may cause a problem that makes the gain small. This is expressed by the following equation (2).

$$\begin{matrix}[ Formula . 2 ] & \\ G = \frac{\frac{{S}_{0}}{{S}_{0} + X} {G}_{0}}{1 + \frac{S}{{S}_{0} + X}} & ( 2 )\end{matrix}$$

In the equation (2), G denotes a gain, Go denotes a small signal gain, S denotes signal input, S₀ denotes saturation signal input, and X denotes crosstalk. From the equation (2), the greater the crosstalk X, the smaller the gain G, and an apparent ASE (total ASE including an ASE of an original core and an ASE of a core adjacent to the original core) increases. This may cause a problem that the noise figure is further deteriorated than a case where only the gain is reduced.

It is an object of the present disclosure to provide an optical fiber amplifier capable of suppressing an increase in crosstalk and a decrease in gain.

### Advantageous Effects of Present Disclosure

According to the present disclosure, it is possible to suppress an increase in crosstalk and a decrease in gain.

### DESCRIPTION OF EMBODIMENTS

First, descriptions will be given in series of the contents of embodiments of the present disclosure. An optical fiber amplifier according to one embodiment is an optical fiber amplifier including a multicore fiber doped with erbium. The multicore fiber is twisted and helically wound to form a fiber coil.

The optical fiber amplifier according to one embodiment includes the multicore fiber doped with erbium. This allows a single optical fiber to amplify a plurality of optical signals and thus allows efficient optical amplification. That is, each core of the multicore fiber is doped with erbium that is a rare earth element. This allows the amplification of the optical signals by raising erbium ions to the excited state using excitation light and thus can make the optical signals highly efficient and low in noise. In the optical fiber amplifier, the multicore fiber is helically wound and twisted. This makes it possible to suppress crosstalk even when the multicore fiber itself does not have a special structure and makes it possible to suppress a decrease in gain. That is, both the twists and the bends can suppress optical coupling between adjacent cores in the multicore fiber.

In the optical fiber amplifier according to one embodiment, the multicore fiber may be twisted at a constant rate along a longitudinal direction of the multicore fiber. Accordingly, the use of the multicore fiber that is twisted at a constant rate along the longitudinal direction makes a section where crosstalk can be large due to lack of twists as short as possible. This in turn makes it possible to reduce crosstalk as compared with a case where the twists are not uniformly made. When twists are uniformly made, crosstalk can be suppressed by about 5 dB, for example.

In the optical fiber amplifier according to one embodiment, the multicore fiber may be twisted one turn per turn of the helix. This makes a section where crosstalk can be large due to lack of twists as short as possible and makes it possible to easily form the fiber coil by twisting the multicore fiber one turn per turn of the helix.

An optical fiber amplifier according to another embodiment is an optical fiber amplifier including a multicore fiber doped with erbium. The multicore fiber is helically wound to form a fiber coil. The multicore fiber includes, in a cross section intersecting a longitudinal direction of the multicore fiber, a center core located at a center of the cross section and outer cores located around the center core. A minimum angle φ formed by a binormal vector extending in an axial direction of the fiber coil and a vector extending from the center core toward one of the outer cores located outside the center core in a radial direction of the helix is at least 0.3°.

Since the optical fiber amplifier according to another embodiment includes the multicore fiber doped with erbium, raising erbium ions to the excited state using excitation light can make the optical signals highly efficient and low in noise. In the cross section intersecting the longitudinal direction of the multicore fiber, the multicore fiber includes the center core located at the center of the cross section and the outer cores located around the center core. Then, the minimum angle φ formed by the binormal vector extending in the axial direction of the fiber coil and the vector extending from the center core toward one of the outer cores located outside the center core in the radial direction of the helix is at least 0.3°. This makes it possible to suppress crosstalk even when the multicore fiber is not twisted and makes it possible to suppress a decrease in gain.

In the optical fiber amplifier according to each of the above-described embodiments, the multicore fiber may have a bending radius of 20 mm or less. This allows the multicore fiber having a bending radius of 20 mm or less to further suppress a decrease in gain and further reduce crosstalk.

The optical fiber amplifier according to each of the above-described embodiments may further include a core having the fiber coil wound around the core. This makes it possible to further suppress a decrease in gain and contributes to further suppression of crosstalk.

### Details of Embodiments

A description will be given of specific examples of the optical fiber amplifier according to the embodiments of the present disclosure with reference to the drawings. It should be noted that the present invention is not limited to the following examples, and is intended to be defined by the claims and to include all modifications within the scope of the claims and their equivalents. Note that, in the following description, the same or equivalent components are denoted by the same reference numerals, and any redundant description will be omitted as appropriate. Further, the drawings may be simplified or exaggerated in part for ease of understanding, and dimensional ratios and the like are not limited to those described in the drawings.

### First Embodiment

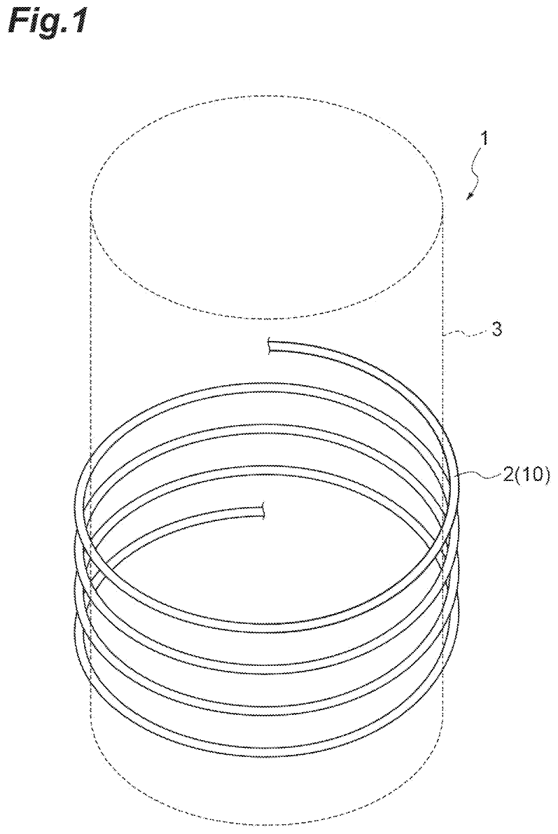

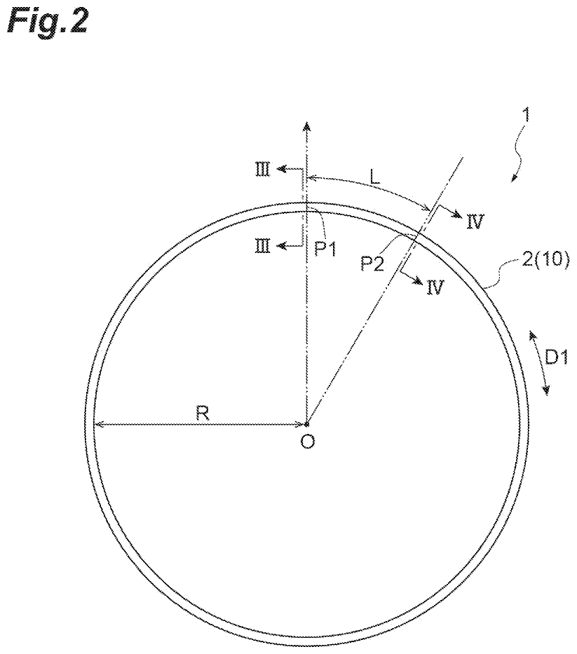

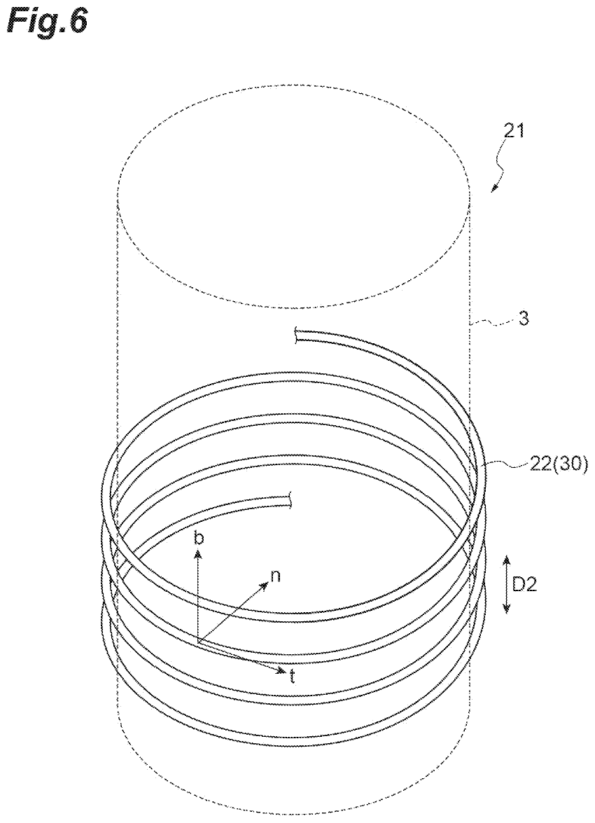

FIG. 1 is a perspective view of an optical fiber amplifier 1 including a fiber coil 2 according to the first embodiment. FIG. 2 is a plan view of the fiber coil 2 of the optical fiber amplifier 1. The optical fiber amplifier 1 amplifies input signal light and outputs amplified signal light. The optical fiber amplifier 1 includes, for example, the fiber coil 2 corresponding to a helically-wound multicore fiber 10, and a core 3 having the fiber coil 2 wound around the core 3. Note that, in FIG. 1 and FIG. 6 to be described later, the core 3 is shown by a dashed line to make the illustration of the multicore fiber clear.

A bending radius R of the multicore fiber 10 is, for example, equal to or greater than 15 mm and equal to or less than 20 mm, but may be changed as needed. The core 3 has, for example, a cylindrical shape. However, the shape and size of the core 3 may be changed as needed. Further, any other structure that can hold the fiber coil 2 eliminates the need of the core 3.

The multicore fiber 10 makes up a multicore erbium (Er)-doped optical fiber amplifier (coupled amplifier) doped with erbium. For example, excitation light is supplied to the multicore fiber 10 of the fiber coil 2 from an excitation light source. As an example, the excitation light source may include a semiconductor laser light source that supplies excitation light having a wavelength of 0.98 μm or a wavelength of 1.48 μm to the multicore fiber 10.

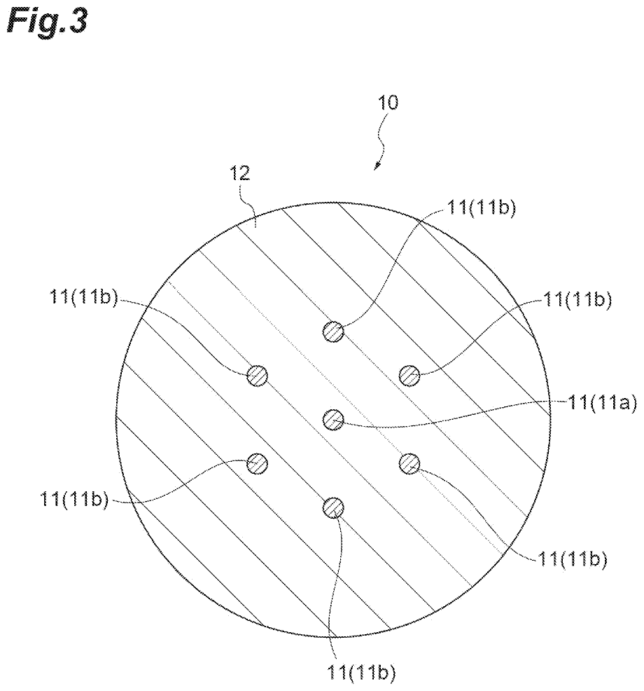

FIG. 3 shows a cross section, taken along line III-III of FIG. 2, of the multicore fiber 10 cut orthogonal to a fiber axis of the multicore fiber 10 at a reference position P1. The multicore fiber 10 includes a plurality of cores 11 doped with Er, and a cladding 12 surrounding the plurality of cores 11. For example, when the excitation light is supplied to the multicore fiber 10, an Er element with which the cores 11 are doped is pumped, and L-band signal light is amplified accordingly.

The multicore fiber 10 includes, for example, seven cores 11. That is, the multicore fiber 10 is a seven-core optical fiber in which the seven cores 11 are arranged in a triangular grid pattern. The cores 11 include one center core 11a located at the center of the cross section of the multicore fiber 10 and six outer cores 11b located around the center core 11a. As an example, the cladding 12 has a diameter of 125 μm, and each of the cores 11 has a diameter of 9 μm. Note that these values may be changed as needed.

The multicore fiber 10 is twisted. Specifically, the multicore fiber 10 is twisted along a longitudinal direction D1 (circumferential direction of the fiber coil 2) of the multicore fiber 10. For example, the multicore fiber 10 is twisted at a constant rate along the longitudinal direction D1. Herein, “twisted at a constant rate along the longitudinal direction” is applied to, with attention paid to a specific section of the multicore fiber in the longitudinal direction, cases other than a case where the specific section is twisted at an exactly constant rate. For example, “twisted at a constant rate along the longitudinal direction” is applied to, with attention paid to at least a part of the specific section, a case where the number of twists per unit length within the part of the specific section falls within a range of ±10% of the average number of twists per unit length within the specific section.

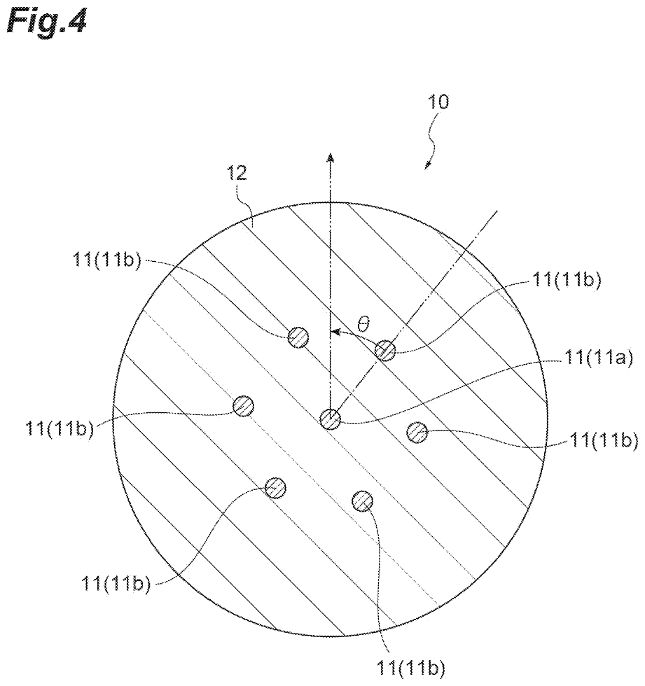

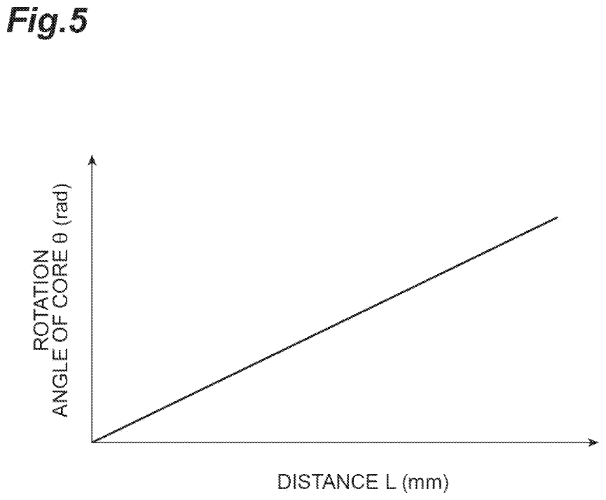

FIG. 4 is a cross-sectional view, taken along line IV-IV of FIG. 2, of the multicore fiber 10 cut orthogonal to the fiber axis of the multicore fiber 10 at a position P2 separated from the reference position P1 by a distance L. FIG. 5 is a graph showing an example of a relation between the distance L in the longitudinal direction D1 of the multicore fiber 10 and a rotation angle θ of the core 11 (outer cores 11b). As shown in FIGS. 2, 4, and 5, for example, the rotation angle θ of the core 11 increases in proportion to the distance L from the reference position P1. That is, in the multicore fiber 10, the position of each outer core 11b is rotated in proportion to the distance L from the reference position P1, thereby causing the outer core 11b to be uniformly twisted.

In other words, the multicore fiber 10 according to the present embodiment need not be irregularly twisted at a specific portion and is twisted, for example, at a constant rate along the longitudinal direction D1. For example, the multicore fiber 10 may be twisted one turn per turn of the helix. In this case, when the distance L is 2πR, θ becomes 360°. Herein, “twisted one turn per turn of the helix” is applied to not only a case where the multicore fiber 10 is twisted exactly one turn, but also a case where the multicore fiber 10 is twisted about one turn such as a case where the multicore fiber 10 is twisted slightly more than one turn or a case where the multicore fiber 10 is twisted slightly less than one turn. For example, “twisted one turn per turn of the helix” is applied to case where 350°≤θ≤370°. Note that the twisting direction may be a clockwise direction in the cross section of the multicore fiber 10 or a counterclockwise direction in the cross section of the multicore fiber 10.

Further, in order to manufacture the optical fiber amplifier 1, visible light is introduced into the outer cores 11b located away from the center of the cross section of the multicore fiber 10. Then, the multicore fiber 10 is wound around the core 3 with the twists of the multicore fiber 10 kept under observation using scattered light to form the fiber coil 2, and, as a result, the manufacture of the optical fiber amplifier 1 is completed.

### Second Embodiment

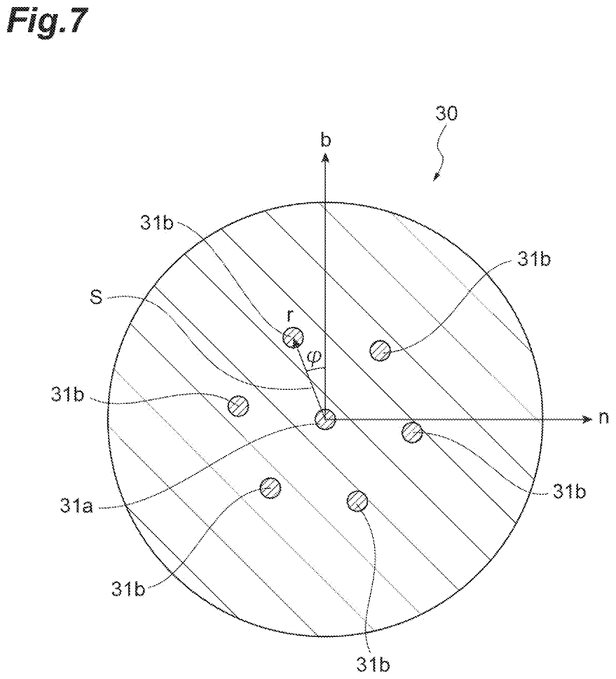

Next, a description will be given of an optical fiber amplifier 21 including a fiber coil 22 according to the second embodiment with reference to FIGS. 6 and 7. The optical fiber amplifier 21 according to the second embodiment is different from the first embodiment in that a multicore fiber 30 is not twisted. In the following description, any redundant description that has been already given for the first embodiment will be omitted as appropriate.

As shown in FIGS. 6 and 7, with a tangent vector of a curve that is the locus of a center of the multicore fiber 30 (center core 31a) denoted by t, a normal vector of the curve that is the locus of the center of the multicore fiber 30 denoted by n, a binormal vector of the curve that is the locus of the center of the multicore fiber 30 denoted by b, and a vector extending from the center core 31a toward an outer core 31b located outside the center core 31a in a radial direction of the helix denoted by r, the minimum angle φ formed by r and b is at least 0.3°.

That is, the angle φ formed by the binormal vector b extending in an axial direction D2 of the fiber coil 22 and a line segment S extending, to the center core 31a, from the outer core 31b located outside the center core 31a in the radial direction of the helix and located closest to the center core 31a in the radial direction of the helix is at least 0.3°. An upper limit of the angle φ is, for example, π/(the number of outer cores 31b) when the outer cores 31b are arranged at equal intervals in the circumferential direction of the cross section of the multicore fiber 30. When the multicore fiber 30 is a seven-core fiber, the upper limit of the angle φ is π/6(rad), that is, 30°, for example.

Next, a description will be given in detail of actions and effects of the optical fiber amplifier 1 according to the first embodiment and the optical fiber amplifier 21 according to the second embodiment. First, the optical fiber amplifier 1 according to the first embodiment includes the multicore fiber 10 doped with Er. This allows a single optical fiber to amplify a plurality of optical signals and thus allows efficient optical amplification. That is, each of the cores 11 of the multicore fiber 10 is doped with Er that is a rare earth element. This allows the amplification of the optical signals by raising Er ions to the excited state using excitation light and thus can make the optical signals highly efficient and low in noise.

Further, in the optical fiber amplifier 1 according to the first embodiment, the multicore fiber 10 is helically wound and twisted. This makes it possible to suppress crosstalk even when the multicore fiber 10 itself does not have a special structure and makes it possible to suppress a decrease in gain. That is, both the twists and the bends can suppress optical coupling between adjacent cores 11 in the multicore fiber 10.

In the optical fiber amplifier 1 according to the first embodiment, the multicore fiber 10 may be twisted at a constant rate along the longitudinal direction D1 of the multicore fiber 10. In this case, the use of the multicore fiber 10 that is twisted at a constant rate along the longitudinal direction D1 makes a section where crosstalk can be large due to lack of twists as short as possible. This in turn makes it possible to reduce crosstalk as compared with a case where the twists are not uniformly made. When the twists are uniformly made, crosstalk can be further suppressed by about 5 dB as described later, for example.

In the optical fiber amplifier 1 according to the first embodiment, the multicore fiber 10 may be twisted one turn per turn of the helix. This makes a section where crosstalk can be large due to lack of twists as short as possible. It is possible to easily form the fiber coil 2 by twisting the multicore fiber 10 one turn per turn of the helix.

The optical fiber amplifier 21 according to the second embodiment includes the multicore fiber 30 doped with erbium as described above. Therefore, raising Er ions to the excited state using excitation light can make the optical signal highly efficient and low in noise. Further, in the cross section intersecting the longitudinal direction D1 of the multicore fiber 30 (for example, the cross section shown in FIG. 7), the multicore fiber 30 includes the center core 31a located at the center of the cross section and the outer cores 31b located around the center core 31a. Then, the minimum angle φ formed by the binormal vector b extending in the axial direction D2 of the fiber coil 22 and the vector r extending from the center core 31a toward one of the outer cores 31b located outside the center core 31a in the radial direction of the helix is at least 0.3°. This makes it possible to suppress crosstalk even when the multicore fiber 30 is not twisted and makes it possible to suppress a decrease in gain.

According to each of the above-described embodiments, the multicore fibers 10, 30 may have the bending radius R of 20 mm or less. This allows the multicore fibers 10, 30 having the bending radius R of 20 mm or less to further suppress a decrease in gain and further reduce crosstalk.

According to each of the above-described embodiments, the optical fiber amplifiers 1, 21 may each further include the core 3 having a corresponding one of the fiber coils 2, 22 wound around the core 3. This makes it possible to further suppress a decrease in gain and contributes to further suppression of crosstalk.

A description will be given in more detail of each of the above-described actions and effects. In the multicore fiber 10, with the power coupling coefficient between cores denoted by η, the wavelength of waveguide light denoted by λ, the effective refractive index when there is no bend denoted by n_{eff}, the distance between cores denoted by r, the bending radius denoted by R_{B}, the fiber length denoted by L, and the power coupling coefficient when there is no bend denoted by κ, the power coefficient between cores η is expressed by the following equation (3).

$$\begin{matrix}[ Formula . 3 ] & \\ η = {J}_{0}^{2} ( \frac{2 π}{λ} \frac{{n}_{eff} r}{{R}_{B}} L ) {sin}^{2} κ L \leq \frac{λ {R}_{B} L}{{π}^{2} {n}_{eff} r} {K}^{2} & ( 3 )\end{matrix}$$

Further, in the multicore fiber 30 having no twist, with the wavelength of waveguide light denoted by λ, the effective refractive index when there is no bend denoted by n_{eff}, the distance between cores denoted by r, the bending radius denoted by R_{B}, the fiber length denoted by L, the power coupling coefficient when there is no bend denoted by κ, and the angle formed by the above-described binormal vector b and vector r denoted by φ, the power coupling coefficient between cores η when the bends are uniformly made is expressed by the following equation (4).

$$\begin{matrix}[ Formula . 4 ] & \\ η = sin {c}^{2} ( \frac{π}{λ} \frac{{n}_{eff} r}{{R}_{B}} L sin φ ) {sin}^{2} κ L & ( 4 )\end{matrix}$$

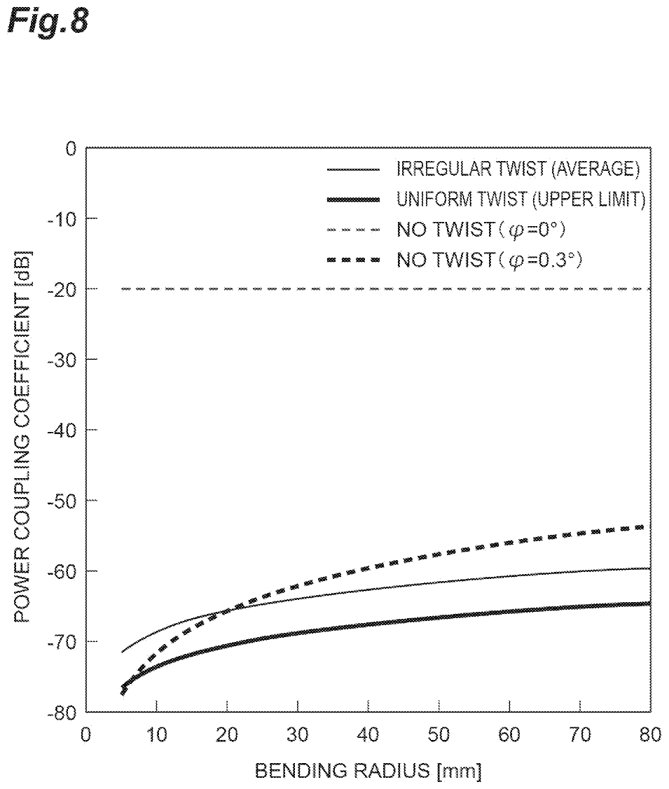

FIG. 8 is a graph showing a relation between the bending radius and the power coupling coefficient based on the equations (3) and (4). As shown in FIG. 8, the smaller the bending radius of the multicore fiber, the more crosstalk can be suppressed, and when the bending radius is equal to or less than 20 mm, crosstalk can be kept to −65 dB or less. It is shown that the multicore fiber 10 having twists (the solid lines in FIG. 8) can reduce crosstalk as compared with a multicore fiber having no twist. A case where the twists are uniformly made (the thick solid line in FIG. 8) can further reduce crosstalk by about 5 dB as compared with a case where the twists are not made uniformly but made irregularly (the thin solid line in FIG. 8). It is also shown that the multicore fiber 30 having no twist and having a φ of 0.3° (the thick dashed line in FIG. 8) can significantly reduce crosstalk as compared with a multicore fiber having no twist and having a φ of 0°.

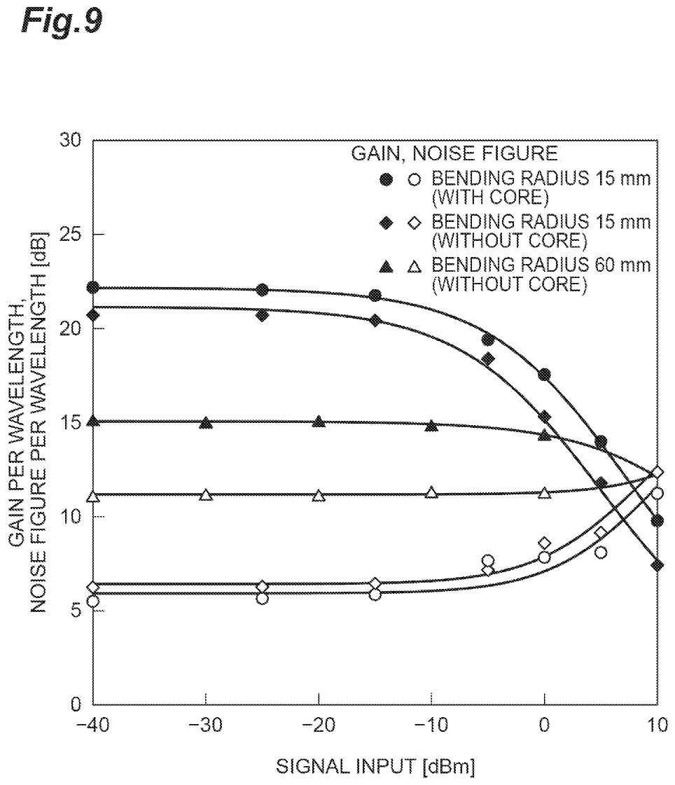

FIG. 9 is a graph showing a relation, obtained by experiment, between the signal input to the fiber coil, and the gain and noise figure based on the presence or absence of the core 3 and the bending radius. FIG. 9 shows that a multicore fiber having a bending radius of 15 mm (the black circle and black rhombus in FIG. 9) is high in gain as compared with a multicore fiber having a bending radius of 60 mm (the black triangle in FIG. 9).

Further, a multicore fiber having a bending radius of 15 mm and having the core 3 (the black circle in FIG. 9) is high in gain as compared with a multicore fiber having a bending radius of 15 mm and having no core 3 (the black rhombus in FIG. 9). It is conceivable that the lack of the core 3 causes stress relaxation to reduce the twists of the multicore fiber and generates a section having no twist, which leads to a decrease in gain and causes crosstalk. Further, it is shown that, with the core 3 provided, when the multicore fiber is wound around the core 3, the multicore fiber is naturally twisted about one turn per turn of the helix, so that the multicore fiber is easily twisted about one turn.

On the other hand, a multicore fiber having a bending radius of 15 mm and having the core 3 (the white circle in FIG. 9) is the lowest in noise figure, a multicore fiber having a bending radius of 15 mm and having no core 3 (the white rhombus in FIG. 9) is the second lowest in noise figure, and a multicore fiber having a bending radius of 60 mm and having no core 3 (the white triangle in FIG. 9) is the highest in noise figure. As described above, it is shown that the multicore fiber having a bending radius of 15 mm and having the core 3 has a particularly good result and can suppress crosstalk more reliably.

Although the embodiments according to the present disclosure have been described above, the present invention is not limited to the above-described embodiments and the above-described examples, and various modifications can be made without departing from the gist described in the claims. That is, the shape, size, material, number, and arrangement of each part of the optical fiber amplifier can be changed as needed without departing from the above gist.

For example, in the above-described embodiments, the multicore fiber twisted one turn per turn of the helix has been described. However, for example, the multicore fiber may be twisted more than half a turn or more than one turn per turn of the helix, and the number of twists of the multicore fiber is not particularly limited.

Further, in the above-described embodiments, the multicore fiber twisted at a constant rate along the longitudinal direction has been described. However, for example, the multicore fiber may be twisted at a specific portion, and the mode of twists is not particularly limited. Further, in the above-described embodiments, the multicore fiber having a bending radius of 20 mm or less has been described. However, a multicore fiber having a bending radius greater than 20 mm may be used, and the value of the bending radius of the multicore fiber may be changed as needed.

### REFERENCE SIGNS LIST

1, 21 optical fiber amplifier
2, 22 fiber coil
3 core
10, 30 multicore fiber
11 core
11a, 31a center core
11b, 31b outer core
12 cladding
D1 longitudinal direction
D2 axial direction
L distance
P1 reference position
P2 position

1. An optical fiber amplifier comprising a multicore fiber doped with erbium, wherein
the multicore fiber is twisted and helically wound to form a fiber coil.

2. The optical fiber amplifier according to claim 1, wherein
the multicore fiber is twisted at a constant rate along a longitudinal direction of the multicore fiber.

3. The optical fiber amplifier according to claim 1, wherein
the multicore fiber is twisted one turn per turn of the helix.

4. An optical fiber amplifier comprising a multicore fiber doped with erbium, wherein
the multicore fiber is helically wound to form a fiber coil,
the multicore fiber includes, in a cross section intersecting a longitudinal direction of the multicore fiber, a center core located at a center of the cross section and outer cores located around the center core, and
a minimum angle φ formed by a binormal vector extending in an axial direction of the fiber coil and a vector extending from the center core toward one of the outer cores located outside the center core in a radial direction of the helix is at least 0.3°.

5. The optical fiber amplifier according to claim 1, wherein
the multicore fiber has a bending radius of 20 mm or less.

6. The optical fiber amplifier according to claim 1 further comprising a core having the fiber coil wound around the core.

7. The optical fiber amplifier according to claim 4, wherein
the multicore fiber has a bending radius of 20 mm or less.

8. The optical fiber amplifier according to claim 4 further comprising a core having the fiber coil wound around the core.

9. The optical fiber amplifier according to claim 4, wherein
an upper limit of the angle φ is π/(the number of outer cores).

10. The optical fiber amplifier according to claim 1, wherein
the multicore fiber is a seven-core optical fiber in which the seven cores are arranged in a triangular grid pattern.

11. The optical fiber amplifier according to claim 4, wherein
the multicore fiber is a seven-core optical fiber in which the seven cores are arranged in a triangular grid pattern.

12. The optical fiber amplifier according to claim 1, wherein
the multicore fiber makes up a multicore erbium (Er)-doped optical fiber amplifier doped with erbium, and excitation light is supplied to the multicore fiber from an excitation light source.

13. The optical fiber amplifier according to claim 12, wherein
the excitation light source includes a semiconductor laser light source that supplies excitation light having a wavelength of 0.98 μm or a wavelength of 1.48 μm to the multicore fiber.

14. The optical fiber amplifier according to claim 4, wherein
the multicore fiber makes up a multicore erbium (Er)-doped optical fiber amplifier doped with erbium, and excitation light is supplied to the multicore fiber from an excitation light source.

15. The optical fiber amplifier according to claim 14, wherein
the excitation light source includes a semiconductor laser light source that supplies excitation light having a wavelength of 0.98 μm or a wavelength of 1.48 μm to the multicore fiber.
